(19) United States
(12) Patent Application Publication
(10) Pub. No.: US 2025/0310358 A1
(43) Pub. Date: Oct. 2, 2025

(54) REAL TIME INFERENCE OF ATTACK PRESENCE WITH MACHINE LEARNING

(71) Applicant: Cisco Technology, Inc., San Jose, CA (US)

(72) Inventors: Lennart Gulikers, Paris (FR); Mukharbek Organokov, Paris (FR)

(73) Assignee: Cisco Technology, Inc., San Jose, CA (US)

(21) Appl. No.: 19/095,637

(22) Filed: Mar. 31, 2025

Related U.S. Application Data
(60) Provisional application No. 63/573,286, filed on Apr. 2, 2024.
(60) Provisional application No. 63/573,288, filed on Apr. 2, 2024.

(51) Int. Cl. H04L 9/40

(52) U.S. Cl. CPC H04L 63/1416; H04L 63/1433

(57) ABSTRACT

In one implementation, a device divides a knowledge graph that represents a potential attack on a cloud computing environment in a plurality of graph slices. The device uses an artificial intelligence model to make predictions as to whether each of the plurality of graph slices are indicative of the potential attack. The device makes a stability assessment as to whether the predictions are stable in part by assessing a gradient between predictions for neighboring graph slices in the plurality of graph slices. The device provides, based on the predictions and the stability assessment, an indication that the potential attack is an actual attack on the cloud computing environment.

### RELATED APPLICATIONS

This application claims priority to U.S. Prov. Appl. Ser. No. 63/573,286, filed Apr. 2, 2024, entitled “REAL TIME INFERENCE OF ATTACK PRESENCE WITH MACHINE LEARNING” by Gulikers, et al. and to U.S. Prov. Appl. Ser. No. 63/573,288, filed Apr. 2, 2024, entitled “DATA AUGMENTATION IN ATTACK SIMULATIONS FOR ENHANCED ATTACK DETECTION” by Gulikers, et al., the contents of which are incorporated herein by reference.

### TECHNICAL FIELD

The present disclosure relates generally to computer networks and, more particularly, to real time inference of attack presence with machine learning.

### BACKGROUND

As cloud computing environments grow in complexity and diversity, they face an escalating wave of sophisticated cyber threats challenging the effectiveness of conventional threat detection mechanisms. These threat detection mechanisms predominantly rely on predefined threat detection rules that aim to identify specific behaviors or steps indicative of a potential threat or attack. The detection rules for threat detection in the cloud are typically defined to identify a specific atomic step of a threat and/or attack. Detection engines may apply these rules in large batches (e.g., tens, hundreds, etc.) to cover as broad a range of threats as possible.

While the threat coverage of these systems is a direct consequence of the number and/or of the diversity of the applied rules, this approach often lacks specificity and adaptability to individual environments. Each cloud environment and/or application deployment may be unique, characterized by its own set of assets, vulnerabilities, associated risks, etc.

Currently, aggregated security findings (e.g., from security utilities such as Falco, etc.) of known full attacks and background activity (e.g., no attack) are available. Presently, there are no existing mechanisms to reliably delineate threats (e.g., classify activity as either malicious (attack) or normal (background)) in real time from these sources due to the complexity and volume of this data.

Further, current approaches to attack simulation rely on extensive, time-consuming simulations that cannot feasibly cover the breadth and depth of potential attack vectors. Moreover, these systems struggle with generalizing from the data that they process, being limited by the scope of the simulated data which typically lacks the variances found in real-world scenarios. Consequently, such systems fail to recognize novel or slightly altered attack patterns, leading to vulnerabilities.

### BRIEF DESCRIPTION OF THE DRA WINGS

The implementations herein may be better understood by referring to the following description in conjunction with the accompanying drawings in which like reference numerals indicate identically or functionally similar elements, of which:

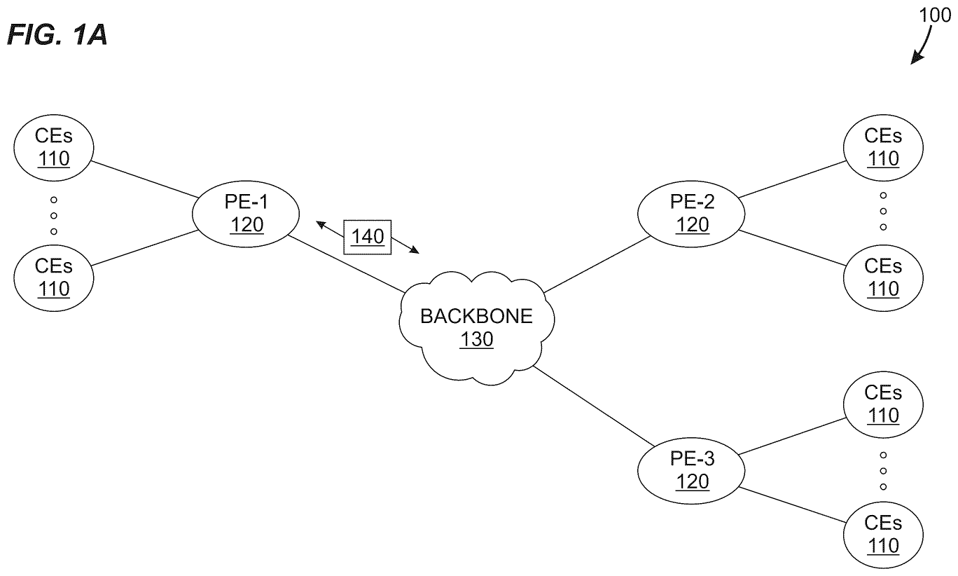

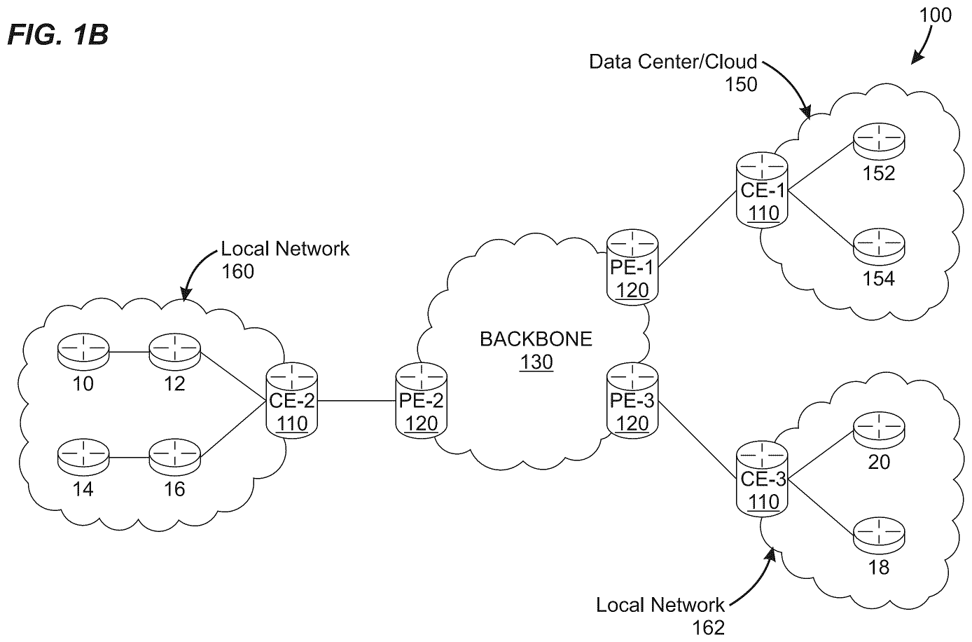

FIGS. 1A-1B illustrate an example communication network;

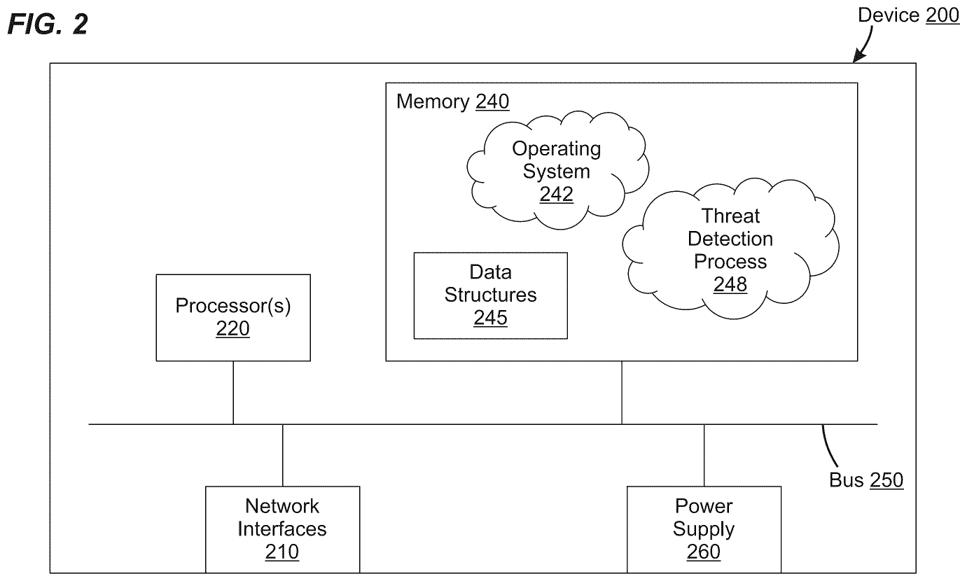

FIG. 2 illustrates an example network device/node;

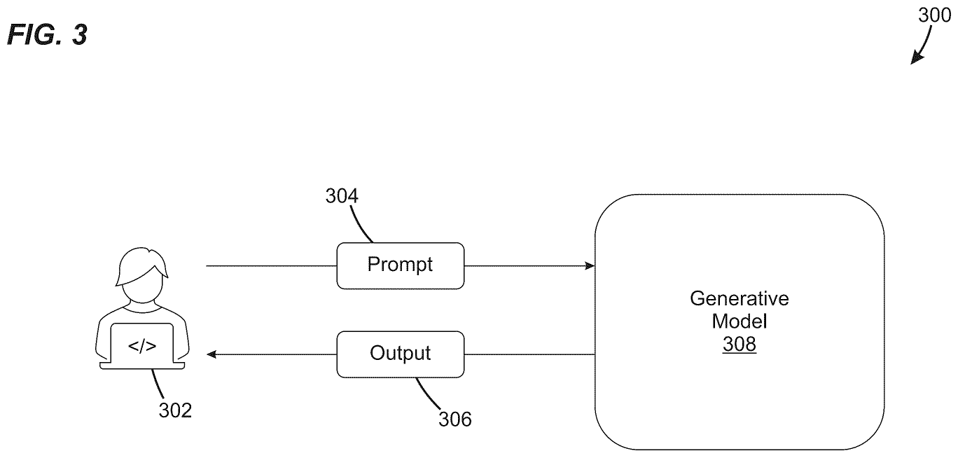

FIG. 3 illustrates an example of a user interfacing with a generative artificial intelligence (AI) model;

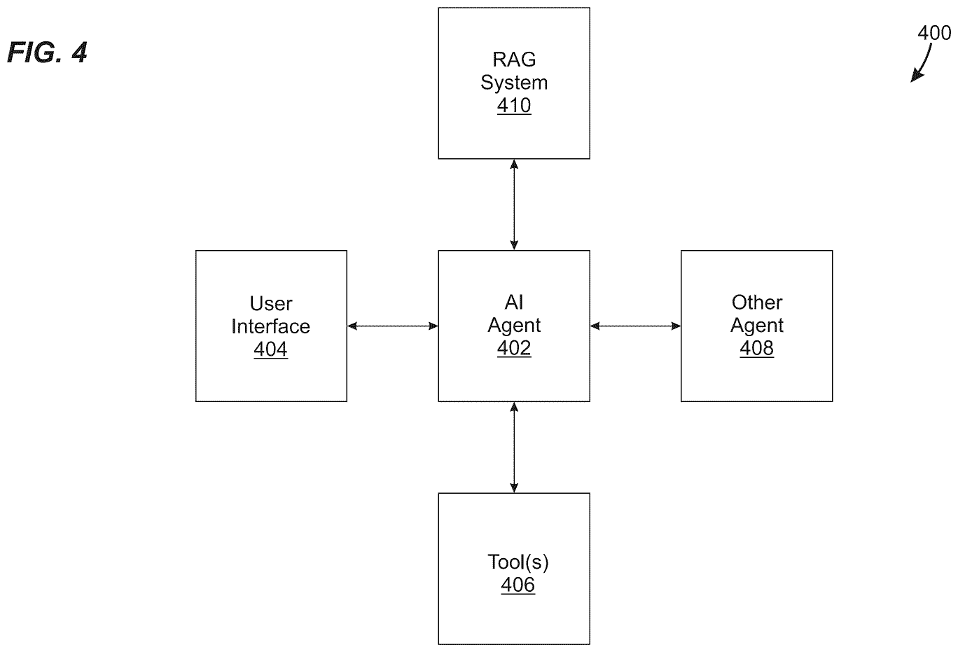

FIG. 4 illustrates an example architecture for an AI agent;

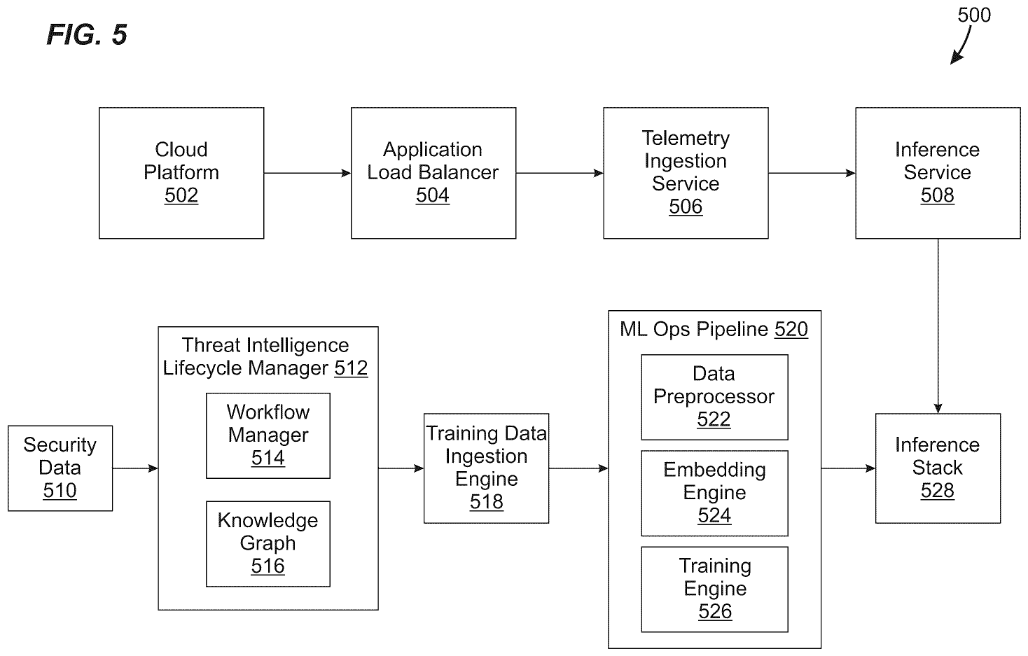

FIG. 5 illustrates an example of an architecture for threat detection in cloud native applications;

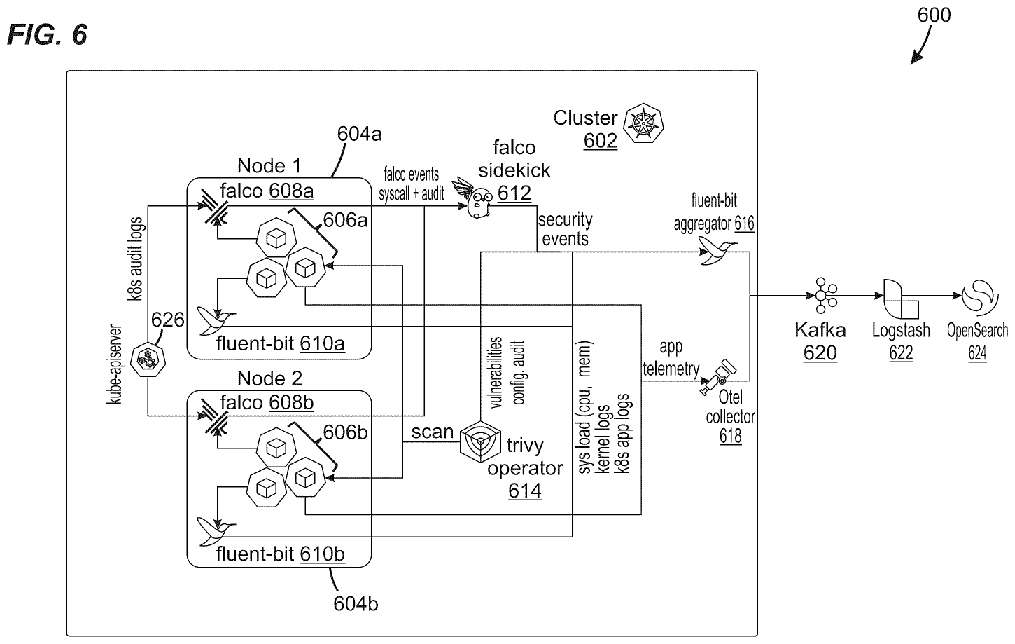

FIG. 6 illustrates an example of a data collection component of a cloud native detection and response architecture;

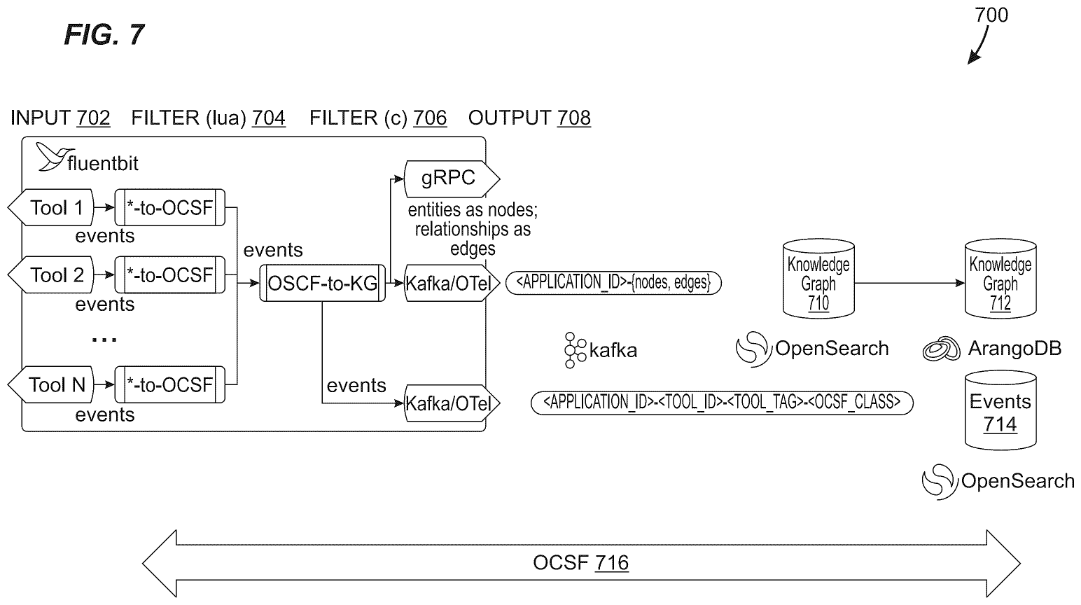

FIG. 7 illustrates an example of a data pipeline component of a cloud native detection and response architecture;

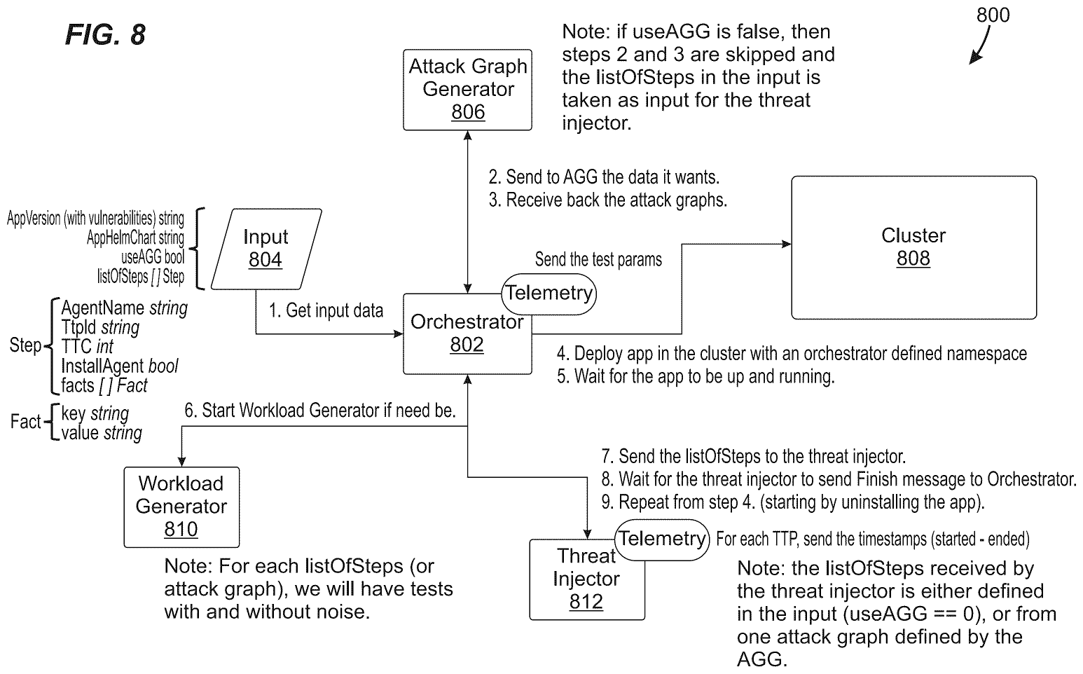

FIG. 8 illustrates an example of a cloud application security testing component of a cloud native detection and response architecture;

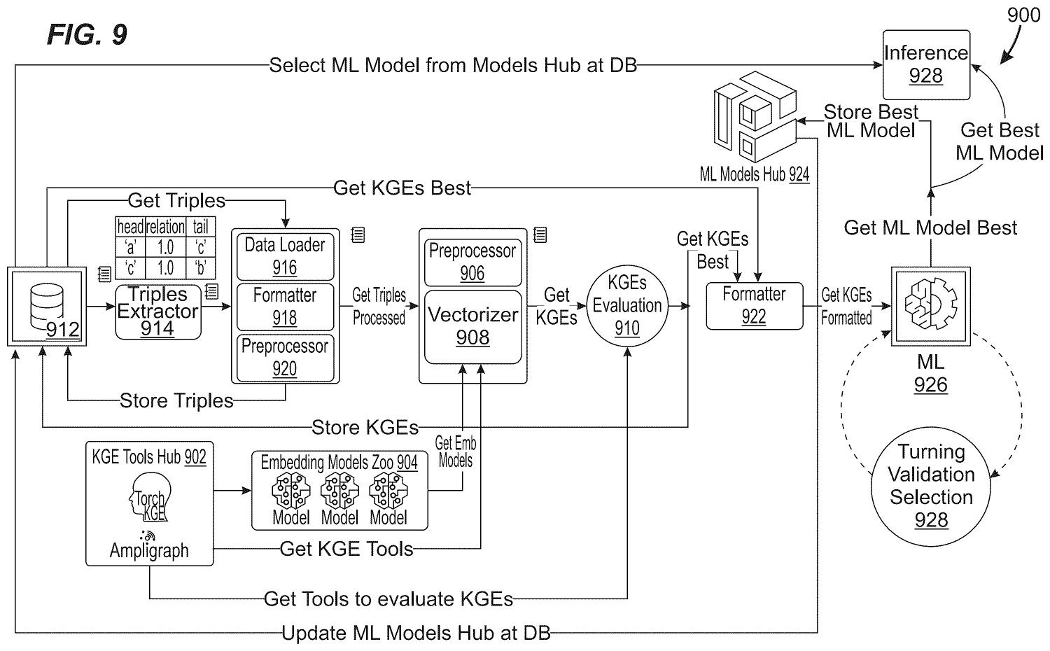

FIG. 9 illustrates an example of a machine learning pipeline component of a cloud native detection and response architecture;

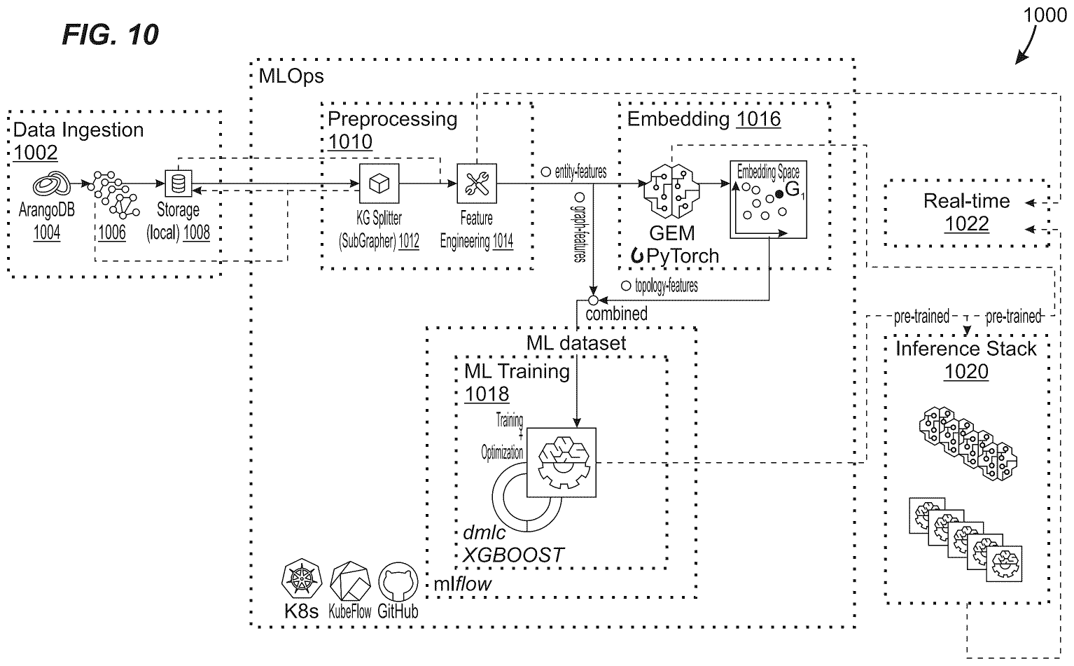

FIG. 10 illustrates an example of a machine learning operations pipeline of a cloud native detection and response architecture;

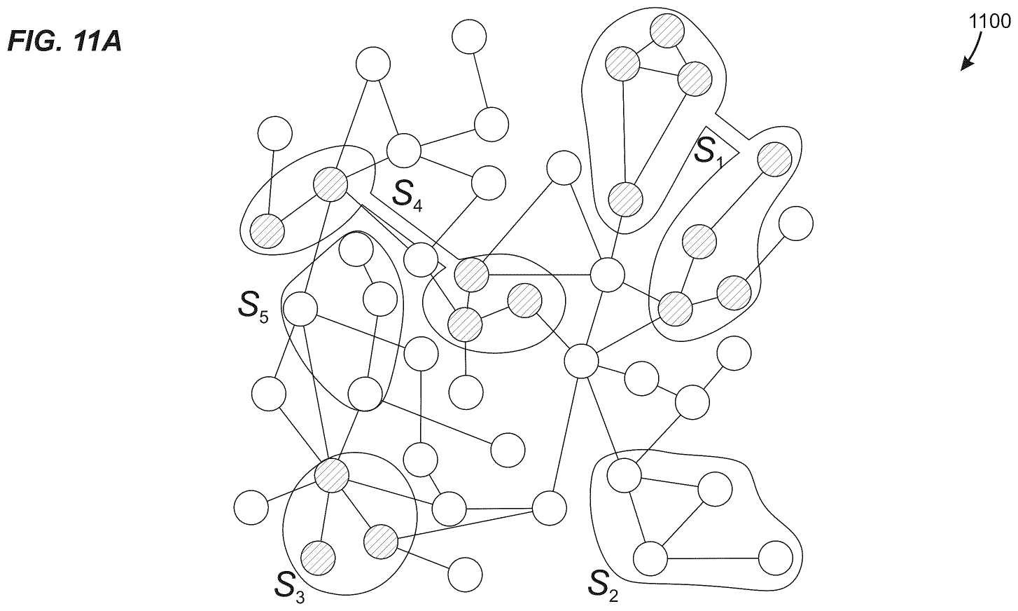

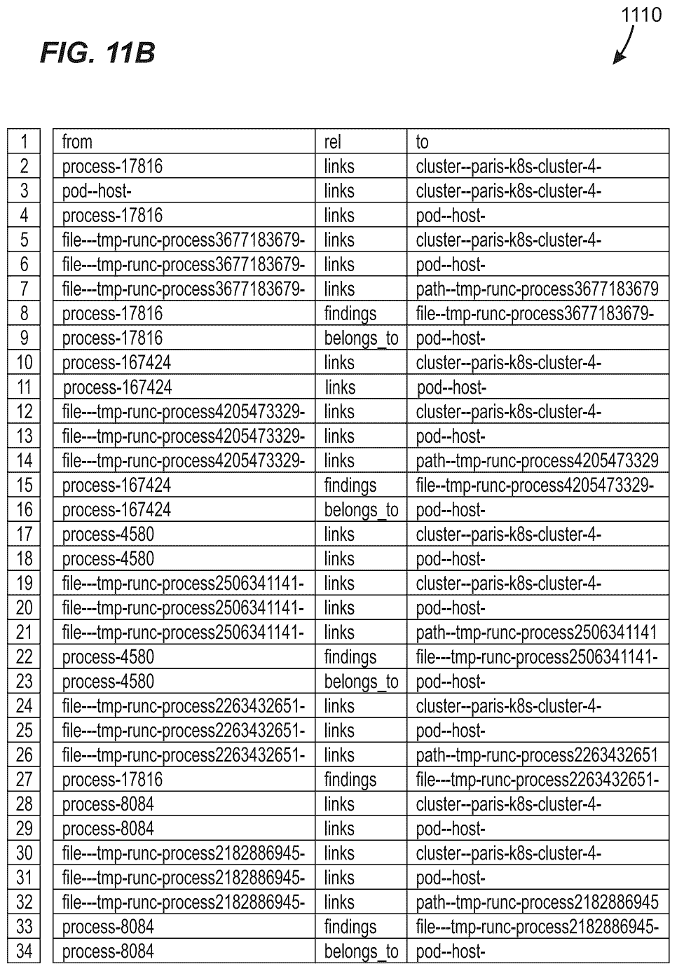

FIGS. 11A-11B illustrate an example of a visualization of a knowledge graph and contextual information utilizable in real time inference of attack presence with AI/machine learning (ML);

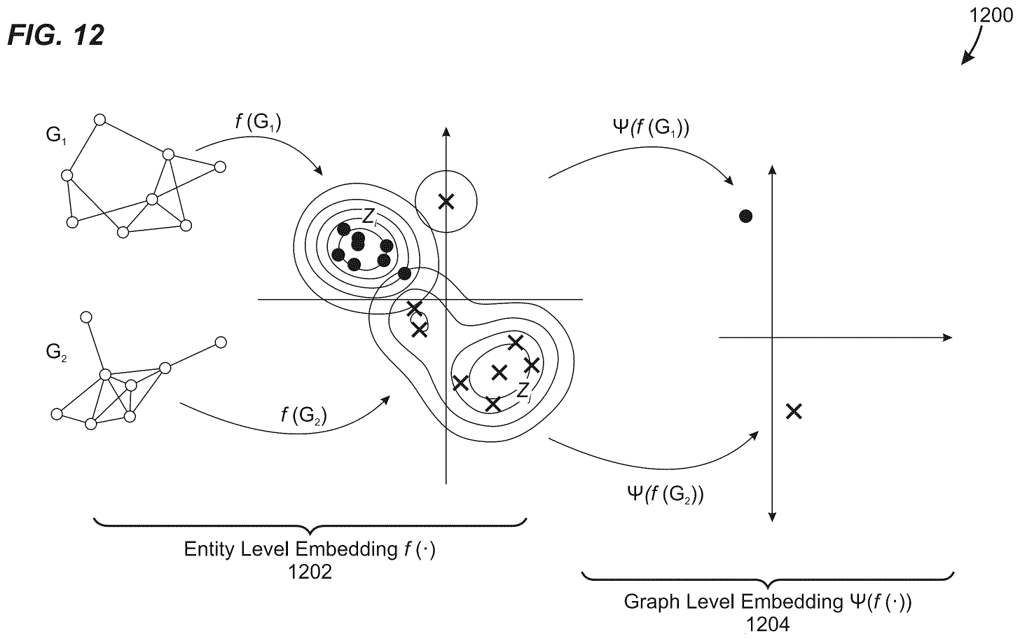

FIG. 12 illustrates an example of an approach for entity and graph level embedding utilizable in real time inference of attack presence with AI/ML;

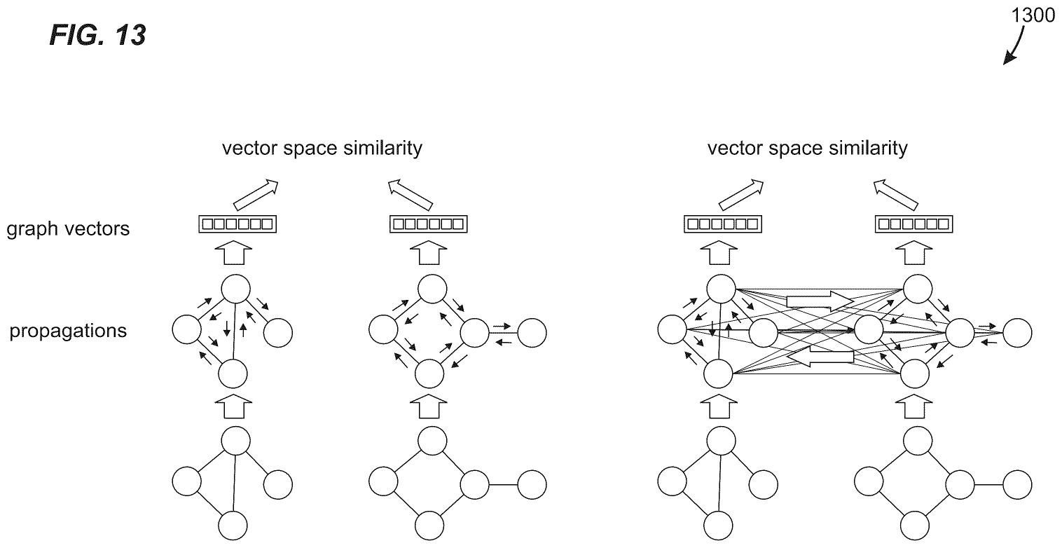

FIG. 13 illustrates an example 1300 of using vector spaces to assess the similarities between graphs;

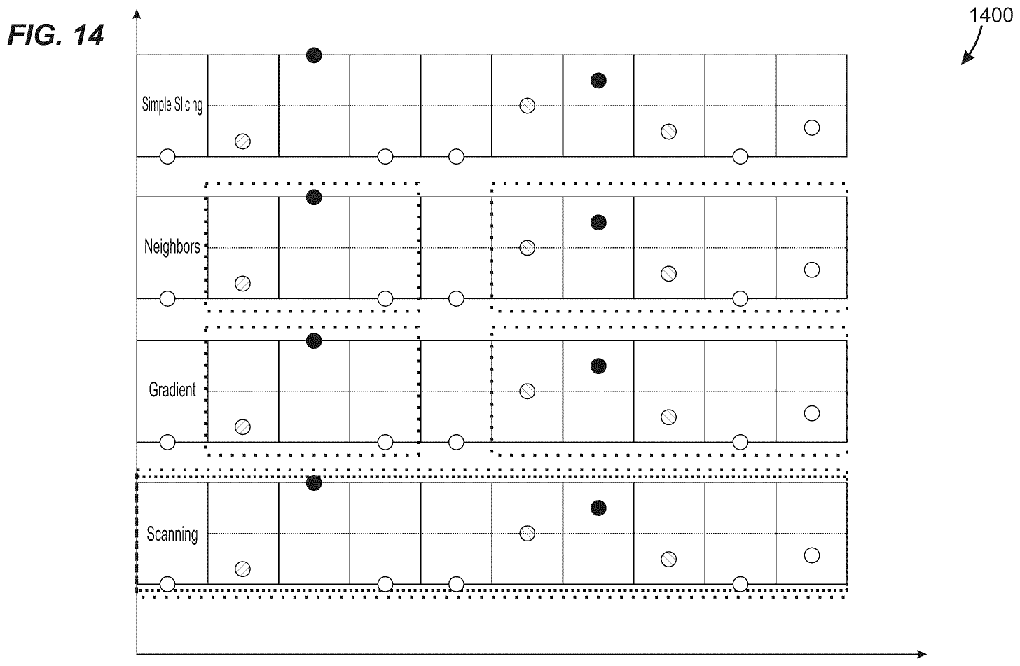

FIG. 14 illustrates an example of a visual summary of the application of different analytical methodologies to data slices in real time inference of attack presence with AI/ML;

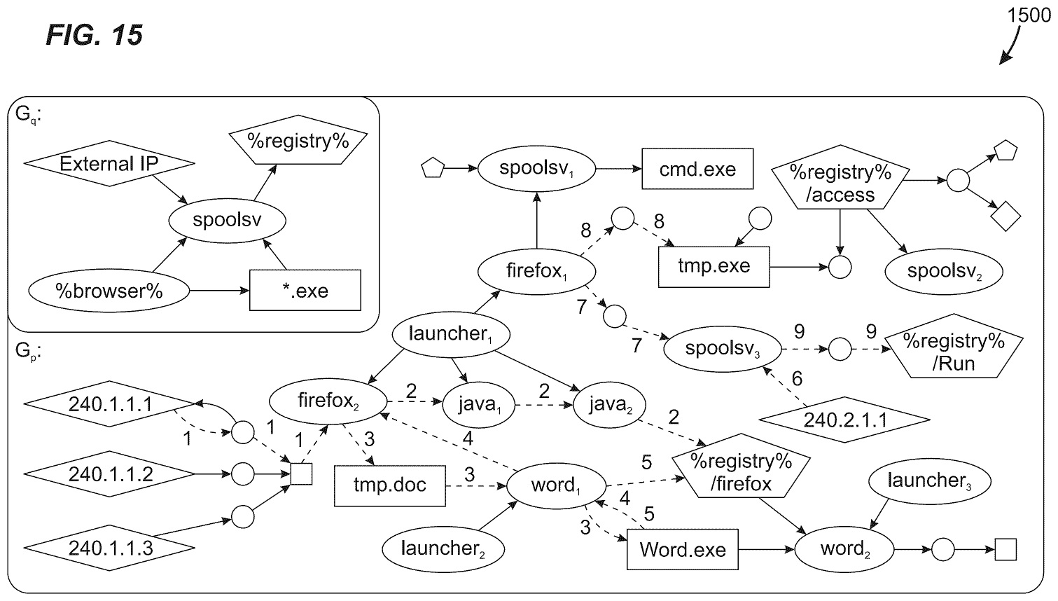

FIG. 15 illustrates an example of a knowledge graph of an attack which may be utilized to provide enhanced attack detection during attack simulations;

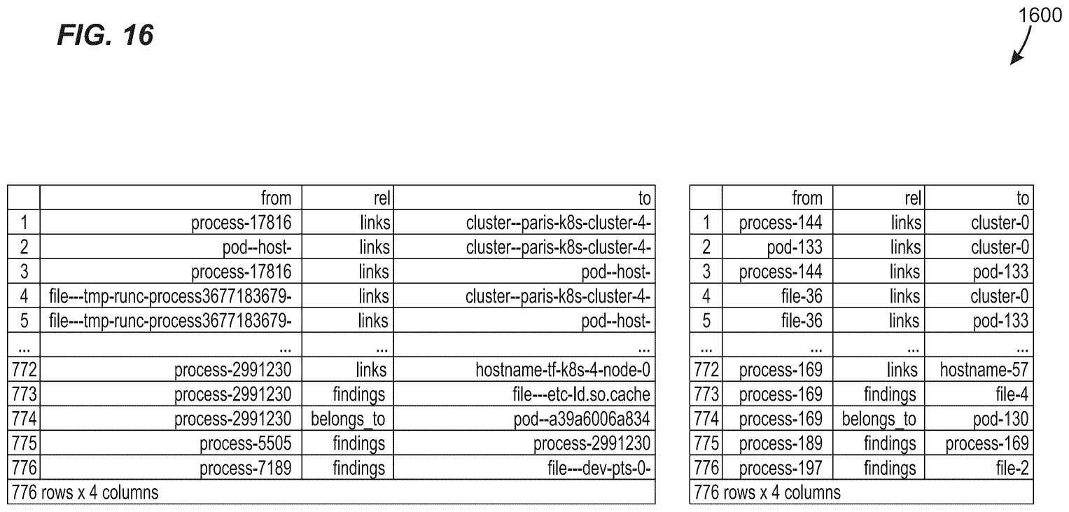

FIG. 16 illustrates an example of a relabeling approach for relabeling entity names in each subgraph to avoid collision;

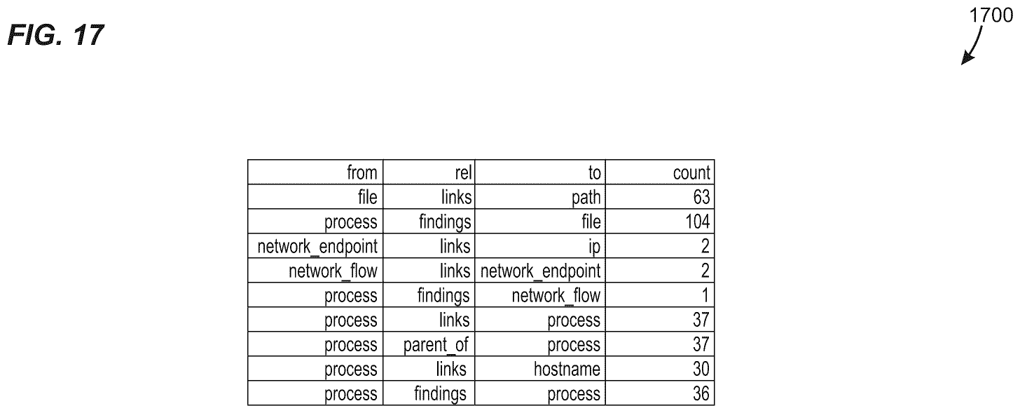

FIG. 17 illustrates an example of an empirical frequency table associated with subgraph insertion into an already existing knowledge graph;

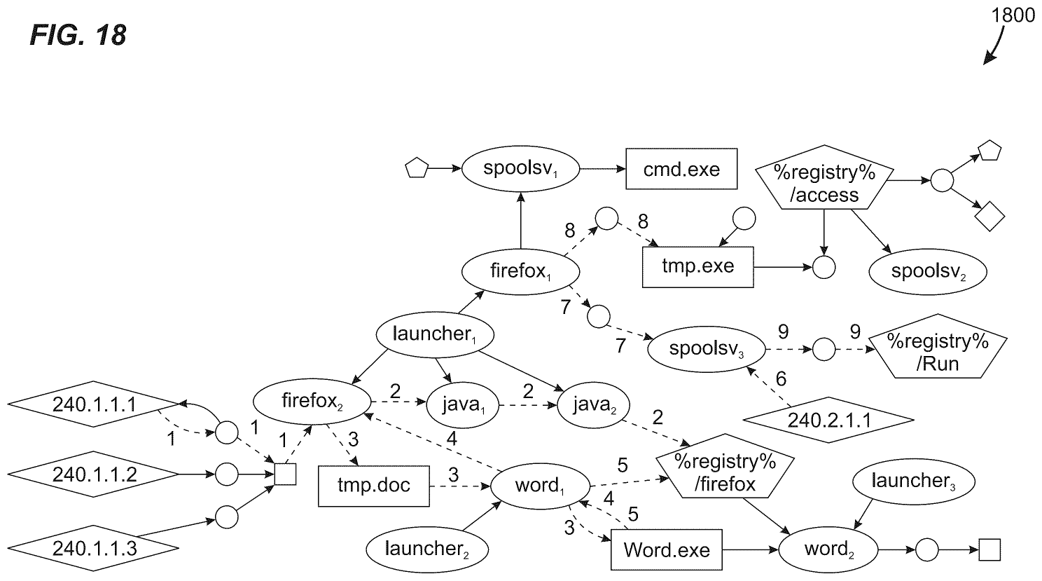

FIG. 18 illustrates an example of an original knowledge graph;

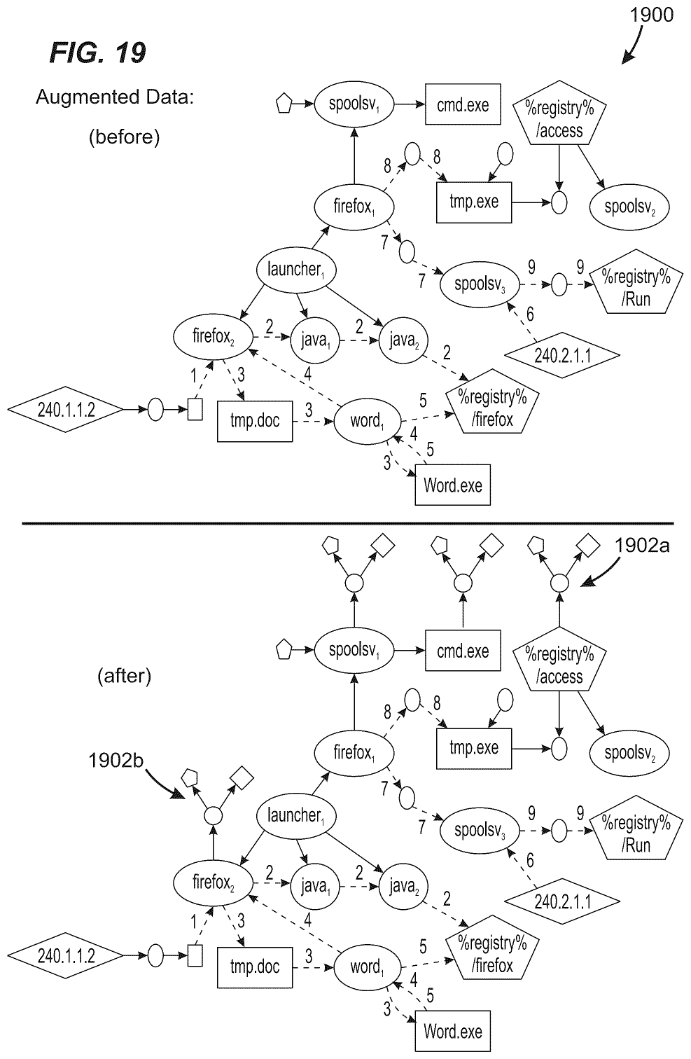

FIG. 19 illustrates an example of the augmentation of the knowledge graph of augmented network data; and

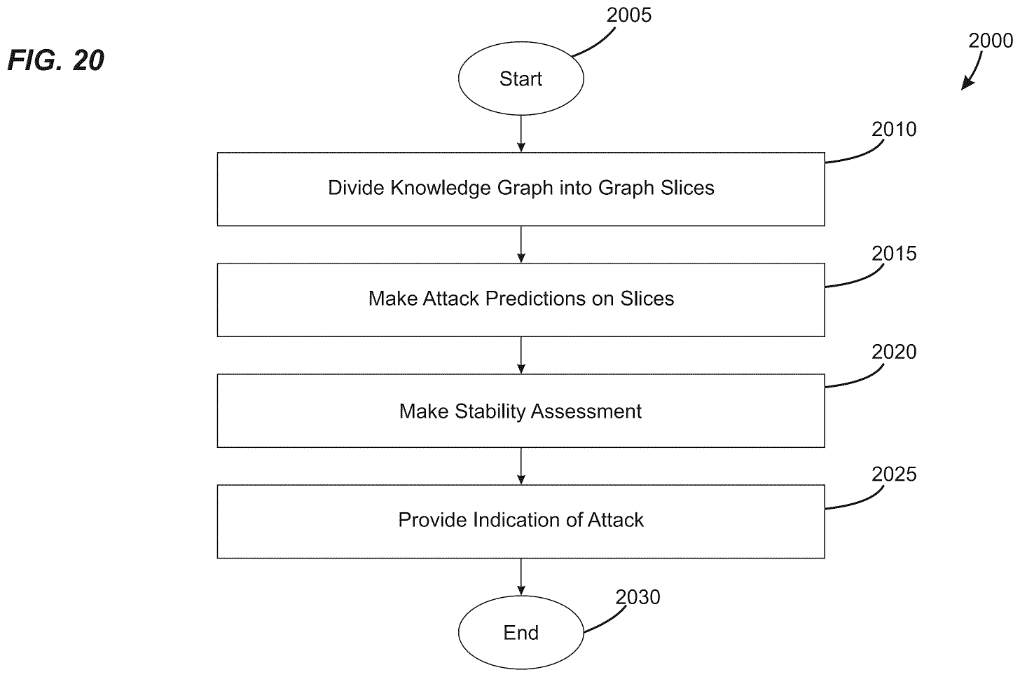

FIG. 20 illustrates an example simplified procedure for real time inference of attack presence with machine learning.

### DESCRIPTION OF EXAMPLE IMPLEMENTATIONS

### Overview

According to one or more implementations of the disclosure, a device divides a knowledge graph that represents a potential attack on a cloud computing environment in a plurality of graph slices. The device uses an artificial intelligence model to make predictions as to whether each of the plurality of graph slices are indicative of the potential attack. The device makes a stability assessment as to whether the predictions are stable in part by assessing a gradient between predictions for neighboring graph slices in the plurality of graph slices. The device provides, based on the predictions and the stability assessment, an indication that the potential attack is an actual attack on the cloud computing environment.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

FIG. 1A is a schematic block diagram of an example of a computer network 100 illustratively comprising nodes/devices, such as a plurality of routers/devices interconnected by links or networks, as shown. For example, customer edge (CE) routers (e.g., CE routers 110) may be interconnected with provider edge (PE) routers (e.g., PE routers 120 PE-1, PE-2, and PE-3) in order to communicate across a core network, such as an illustrative network backbone (e.g., network backbone 130). For example, CE routers 110 and PE routers 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router (e.g., CE routers 110) shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router connected to PE-2 and a second CE router connected to PE-3.

FIG. 1B illustrates an example of computer network 100 in greater detail, according to various implementations. As shown, network backbone 130 may provide connectivity between devices located in different geographical areas and/or different types of local networks. For example, computer network 100 may comprise local/branch networks (local networks 160, local networks 162, etc.) that include devices/nodes 10-16 and devices/nodes 18-20, respectively, as well as a data center/cloud environment 150 that includes servers 152-154. Notably, local networks 160 and local networks 162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in computer network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more network interfaces (e.g., network interfaces 210), one or more processors (e.g., processor(s) 220), and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components and/or services may comprise a threat detection process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, threat detection process 248 may include computer-executable instructions that, when executed by processor(s) 220, cause device 200 to perform the techniques described herein. To do so, in some implementations, threat detection process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, threat detection process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that threat detection process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, threat detection process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, generative adversarial networks (GANs), large language models (LLMs) and other foundation models, diffusion models, transformer models, and the like.

FIG. 3 illustrates an example 300 for interfacing with a generative AI model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be an AI model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

AI agents are also capable of interacting with generative models, such as generative model 308, which may be integrated directly into the agent or accessed via an application programming interface (API). Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc.

In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

FIG. 4 illustrates an example architecture 400 for an artificial intelligence (AI) agent, according to various implementations. At the core of architecture 400 is AI agent 402. As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain.

For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Often, a RAG system stores this contextual information in a vector database for quick retrieval using semantic searching, although other implementations are also possible.

### Cloud Native Threat Detection and Response Architecture

As noted above, threat detection in cloud native application deployments can be challenging. This is largely because of the heterogeneousness of cloud platforms and the current use of static definitions to detect and respond to threats. Despite this, cloud native application security solutions are increasingly called upon to provide coverage across a variety of cloud platforms, Kubernetes clusters, and API resources, while offering prioritization of the most critical risks and vulnerabilities for rapid threat identification and remediation. To address this, the techniques herein introduce a cloud native threat detection and response architecture that is able to detect and respond to threats in (near) real time.

Illustratively, the techniques described herein may be performed by hardware, software, and/or firmware which may include computer executable instructions executed by the processor(s) 220 (or independent processor of network interfaces 210) to perform functions relating to the techniques described herein, such as in conjunction with threat detection process 248.

FIG. 5 illustrates an example of an architecture 500 (e.g., a cloud native detection and response architecture) for threat detection in cloud native applications, according to various implementations. According to various implementations, architecture 500 may utilize AI/machine learning to collect and process data from applications and other sources, to manage a threat intelligence lifecycle. As detailed below, this may include the training, evaluating, improving, and/or applying of AI/machine learning models for purposes of threat detection in cloud native applications. In addition, this may include managing data analysis and event notification resulting from the application of the machine learning models.

As shown, assume that there is a cloud platform 502 in which one or more online applications are executed. In some implementations, cloud platform 502 make take the form of a management platform for virtualized or containerized applications, such as Kubernetes. Such implementations allow for an online application to be divided into microservices, which are smaller, independent software components that can be executed in conjunction with one another to serve the application to users via a computer network.

An application load balancer 504 may interact with cloud platform 502 for various purposes, such as coordinating the execution of multiple applications within cloud platform 502. In some instances, application load balancer 504 may also function as a collection point for observability information regarding the execution and performance of the application(s) within cloud platform 502. For instance, cloud platform 502 may execute any number of telemetry collection utilities such as, but not limited to, the Falco daemonset, eBPF, Fluent Bit, Open Cybersecurity Schema Framework (OCSF) data collection utilities, OpenTelemetry (OTel), or the like. Application load balancer 504 or another component may obtain such telemetry/observability data from these utilities via a remote procedure call (RPC), gRPC, HTTP, or the like.

In turn, a telemetry ingestion service 506 may ingest the telemetry/observability data for threat assessment by inference service 508. To do so, telemetry ingestion service 506 may include the corresponding software components needed to ingest the various data generated by the utilities in cloud platform 502 for purposes of observability. For instance, if cloud platform 502 collects OTel data regarding its operation, telemetry ingestion service 506 may include an OTel collector. Similarly, if cloud platform 502 includes the Falco daemonset, telemetry ingestion service 506 may include a notification engine to forward Falco events. Of course, the specific components of telemetry ingestion service 506 may differ, depending on the type(s) of telemetry/observability data that cloud platform 502 collects.

Telemetry ingestion service 506 may further include any number of data streaming utilities, to provide the data that telemetry ingestion service 506 collects in a unified manner. For instance, telemetry ingestion service 506 may leverage Amazon Managed Streaming for Apache Kafka (MSK), to make the telemetry/observability data from cloud platform 502 available for use by inference service 508.

According to various implementations and as detailed further below, architecture 500 may also include an inference service 508 that uses AI/machine learning to assess the telemetry/observability data from cloud platform 502, to detect any potential security threats. As shown, inference service 508 may do so by leveraging an inference stack 528 that uses one or more AI/machine learning models that have been trained to identify threats within a cloud environment, such as cloud platform 502. In one implementation, the mode(s) may also identify one or more corrective measures that

Architecture 500 may also include the training pipeline for the model(s) that underlies inference stack 528. For instance, architecture 500 may include a threat intelligence lifecycle manager 512 that is configured to take as input the security data 510. Generally, security data 510 may include a description of a security threat and may include any related information as well (e.g., remediation actions, etc.). For instance, security data 510 may include OCSF data that is streamed to workflow manager 514 of threat intelligence lifecycle manager 512 via a streaming mechanism such as Apache Kafka or the like.

In some implementations, threat intelligence lifecycle manager 512 may use security data 510 obtained by workflow manager 514 to populate a knowledge graph 516. Here, knowledge graph 516 may take the form of a graph-based data structure with nodes representing objects (e.g., components of cloud platform 502, concepts, etc.) and edges between those nodes representing their relationships. In one implementation, threat intelligence lifecycle manager 512 may store knowledge graph 516 in a graph database such as AarangoDB or the like.

Training data ingestion engine 518 may take as input the security data 510 stored in knowledge graph 516 and provide it to ML Ops pipeline 520 for training of the model(s) used in inference stack 528. To this end, ML Ops pipeline 520 may include a data preprocessor 522 responsible for data preprocessing tasks such as splitting knowledge graph 516 into subgraphs, performing feature engineering, or the like.

In some implementations, ML Ops pipeline 520 may also include an embedding engine 524 that is responsible for converting the data from data preprocessor 522 into vector embeddings. These vector embeddings may represent the (sub) graph formed by data preprocessor 522 into numerical representations. For instance, embedding engine 524 may leverage PyTorch or other suitable mechanism to form the embeddings.

Finally, ML Ops pipeline 520 may include a training engine 526 that uses the embeddings from embedding engine 524 to train the model(s) of inference stack 528. For instance, training engine 526 may use XGBoost (eXtreme Gradient Boosting), which is able to build decision trees over time. In addition, training engine 526 may also be configured to optimize a trained model through techniques such as reinforcement learning,

FIG. 6 illustrates an example of a data collection component 600 of a cloud native detection and response architecture, such as architecture 500, according to various implementations. More specifically, FIG. 6 illustrates an example implementation of the various telemetry/observability data collection and reporting functions that could observe and report on the operations of cloud platform 502.

For instance, as shown, consider the case of a Kubernetes cluster 602 within cloud platform 502. Such a cluster may include any number of pods such as pods 606a executed within a first node 604a, pods 606b executed within a second node 604b, etc. Each pod may run a separate container in which a portion of the online application (e.g., a microservice, etc.) may execute.

To monitor the operations and performance within Kubernetes cluster 602, there may be various tools/processes within each node 604. For instance, within first node 604a may be Falco tools 608a, Fluent Bit tools 610a, or the like. Similarly, within second node 604b may be Falco tools 608b, Fluent Bit tools 610b, etc. The Kubernetes API server 626, kube-apiserver, within Kubernetes cluster 602 may provide audit logs to Falco tools 608a and to Falco tools 608b, which may provide the resulting Falco events, system calls, and audit information to a Falco sidekick 612 within Kubernetes cluster 602, so that it can report any observed system events.

Fluent Bit tools 610a and Fluent Bit tools 610b may likewise report their logs (e.g., application logs, kernel logs, etc.), metrics (e.g., system load metric such as CPU metrics, memory metrics, etc.) to a Fluent Bit aggregator 616 within Kubernetes cluster 602.

In some implementations, Kubernetes cluster 602 may also include other observability tools, as well. For instance, OTel collector 618 may collect application telemetry in OTel format for reporting. In addition, Trivy Operator may scan Kubernetes cluster 602 for security issues and report on any detected vulnerabilities, the results of any audits (e.g., configuration audits, etc.), or the like.

Regardless of the specific observability utilities within Kubernetes cluster 602, data collection component 600 may also include utilities to make the telemetry/observability data that they collect available for use by the other components of architecture 500. For instance, data collection component 600 may use a Kafka-based deployment 620 to collect the telemetry/observability data from Kubernetes cluster 602. As would be appreciated, Apache Kafka is an open-source, event streaming platform.

Another potential utility that data collection component 600 could use is a Logstash deployment 622. Generally, Logstash is a server-side data processing pipeline that is able to ingest data from multiple sources, perform data transformations on that data, and make it available.

Finally, data collection component 600 could also make use of an OpenSearch deployment 624, to make its collected telemetry/observability data available within architecture 500. OpenSearch is another open-source platform that supports data searching and analytics. As would be appreciated, deployments 620-624 could also operate in conjunction with one another as Logstash is part of the OpenSearch stack and a Kafka plugin could provide the data for ingestion by the stack.

FIG. 7 illustrates an example of a data pipeline component 700 of a cloud native detection and response architecture, such as architecture 500, according to various implementations. For example, data pipeline component 700 may be responsible for providing the security data 510 on which architecture 500 trains its AI model(s). As shown, data pipeline component 700 may operate within an Open Cybersecurity Schema Framework (OCSF) 716.

In some implementations, data pipeline component 700 may leverage a FluentBit deployment having N-number of tools as part of its input 702. In turn, any FluentBit events may undergo a first filter, to convert the events into OCSF format. Data pipeline component 700 may then apply a second filter 706 to provide that OCSF information for storage in a knowledge graph.

At output stage 708, data pipeline component 700 may provide the collected information using any number of suitable connectors. By way of example, data pipeline component 700 may output the collected OCSF events using Kafka, OTel, or the like. Similarly, data pipeline component 700 may use gRPC to output information regarding the entities in the cloud environment and their relationships.

In various implementations, data pipeline component 700 may provide the information about the cloud entities to form a knowledge graph 710 that represents the various entities associated with a given application as nodes and their relationships. For instance, output stage 708 may output messages using the following format:
<APPLICATION_ID> {nodes, edges}
   which the output stage 708 could make available through Kafka or another streaming mechanism. Data pipeline component 700 may then construct knowledge graph 710 within OpenSearch and make it available as knowledge graph 712 via a suitable database, such as ArangoDB, which is a graph database.

Similarly, output stage 708 of data pipeline component 700 may output messages regarding the events 714 related to the application using the following format:

<APPLICATION_ID><TOOL_ID><TOOL_TAG><OCSF_CLASS>

In turn, this information could be ingested using OpenSearch or another suitable component.

FIG. 8 illustrates an example of a cloud application security testing component 800 of a cloud native detection and response architecture, such as architecture 500, according to various implementations. In some implementations, cloud application security testing component 800 may actively test the application and cloud platform, to identify potential threats and assess how the platform reacts to certain changes.

At the core of cloud application security testing component 800 may be an orchestrator 802 that is responsible for orchestrating the testing of the cloud platform. To this end, orchestrator 802 may take input 804 as input, such as an indication of the application's version, the Helm chart of the application (if hosted in Kubernetes), a flag indicating whether cloud application security testing component 800 should generate an attack graph, a list of steps that orchestrator 802 should take, or the like. In cases in which the list of steps is specified, a given step may indicate the agent's name, Tactics, Techniques, and Procedures (TTP) ID, the install agent, any associated facts (e.g., one or key-value pairs), or the like.

If so requested, orchestrator 802 may then request that attack graph generator 806 generate a corresponding attack graph for the application and cloud environment. Attack graph generator 806 may then return the attack graph(s) to orchestrator 802. Of course, if the request flag, useAGG, in input 804 is false, orchestrator 802 may skip seeking the attack graphs from attack graph generator 806. In some instances, cloud application security testing component 800 may use the generated attack graph(s) in lieu of any explicitly-specified steps in input 804.

In turn, orchestrator 802 may deploy the application in cluster 808 of the cloud environment with an orchestrator-defined namespace. Orchestrator 802 may then wait for the application to be up and running, before initiating its testing. In some case, orchestrator 802 may also call workload generator 810 that is configured to generate workloads for the application to perform. In one implementation, for each of the list of steps or a given attack graph, workload generator 810 may generate tests with and without noise.

Orchestrator 802 may also send the list of steps to threat injector 812. In various instances, the list of steps may be defined via input 804 or, alternatively, by an attack graph from attack graph generator 806. In turn, threat injector 812 may inject the threat into cluster 808, allowing it to collect telemetry regarding how the application and cloud environment reacted to the threat. Threat injector 812 may then return the collected telemetry back to orchestrator 802 and notify it that the threat injection test has finished. Orchestrator 802 may then repeat the above any number of times by reinstalling the application and running another test.

FIG. 9 illustrates an example of a machine learning pipeline component 900 of a cloud native detection and response architecture, such as architecture 500, according to various implementations. Machine learning pipeline component 900 may be utilized to perform training and/or inference of machine learning models to be utilized in detection of threats to cloud native applications. For instance, in the context of architecture 500, inference service 508 may use machine learning pipeline component 900 to make inferences (e.g., threat assessments) using model hub 924 as inference stack 528.

As shown, machine learning pipeline component 900 may include a knowledge graph embedding (KGE)-based KGE tools hub 902 that makes available a zoo 904 of embedding models. For instance, KGE tools hub 902 may take the form of an AmpliGraph deployment.

Data processing by machine learning pipeline component 900 may entail a triplet extractor 914 getting triplets from database 912. In turn, data loader 916, formatter 918, and preprocessor 920 may perform their respective functions and send the triplets to preprocessor 906 and vectorizer 908 for further processing. Machine learning pipeline component 900 may also store new triplets in database 912 as they become available.

Machine learning pipeline component 900 may also perform an evaluation 910 of the KGEs, to select the best KGEs. In some instances, formatter 922 may then format the selected KGEs, in order to select and/or train the best AI/ML model 926 available for inferencing. In some cases, machine learning pipeline component 900 may also include a model hub 924 in which the best model (e.g., ML model 926) and/or any other models are stored (e.g., within database 912).

When it is time to perform inferencing, machine learning pipeline component 900 may retrieve ML model 926 and use it to make inference 928 regarding the (near-) real-time telemetry/observability data collected from cloud platform 502.

FIG. 10 illustrates an example of a machine learning operations pipeline 1000 of a cloud native detection and response architecture, such as architecture 500, according to various implementations. In general, machine learning operations pipeline 1000 may be responsible for training and updating the AI/machine learning model that the system uses for making inferences (e.g., to implement ML Ops pipeline 520).

As shown, machine learning operations pipeline 1000 may take as input the data captured by data ingestion mechanism 1002 (e.g., data pipeline component 700). Generally, data ingestion mechanism 1002 may capture information regarding the cloud platform and formulate a knowledge graph that represents the entities and their interactions within the cloud platform when the application is executed. In turn, data ingestion mechanism 1002 may turn this information into a knowledge graph 1006 stored in a graph database 1004 within local storage 1008.

A preprocessing component 1010 (e.g., data preprocessor 522 in FIG. 5) may include a knowledge graph splitter 1012 configured to split the knowledge graph into subgraphs. Preprocessing component 1010 may also include a feature engineering engine 1014 configured to perform feature engineering on the subgraphs from knowledge graph splitter 1012 and/or the full knowledge graph from data ingestion mechanism 1002. As would be appreciated, feature engineering entails transforming data into features that an AI/machine learning model can use to make predictions.

In turn, an embedding component 1016 may convert the entity features into embeddings within an embedding space that represents the various features of the topology of those entities within the cloud environment. Machine learning operations pipeline 1000 may then combine the topology features and the graph features into a machine learning dataset. As would be appreciated, embedding component 1016 may itself be trained and optimized over time, similar to machine learning training engine 1018, in some instances.

Machine learning training engine 1018 may then use the combined dataset for purposes of training and optimizing an AI/machine learning model that the system can use within inference stack 1020 to make real-time inferences 1022 regarding the operations of the application within the cloud environment.

### Real Time Inference of Attack Presence with Machine Learning

As noted above, there are no existing mechanisms to reliably delineate threats (e.g., classify activity as either malicious (attack) or normal (background)) in real time from aggregated security findings due to the complexity and volume of this data. This leads to delayed time-sensitive responses to actual attacks and/or the misidentification of normal background activities as threats. This results in a precarious security stance, where the inability to differentiate between benign activity and genuine attacks in a timely manner exposes systems to the risk of sustained vulnerabilities.

In contrast, the techniques herein facilitate the real time inference of attack presence with machine learning. This approach may utilize real time data slicing and advanced machine learning embeddings to pierce through the veil of complexity, enabling the swift discernment of malicious activities. This not only mitigates latency issues but also significantly elevates the accuracy of threat detection, thereby bolstering the security posture of a monitored system.

Specifically, according to various implementations, a device divides a knowledge graph that represents a potential attack on a cloud computing environment in a plurality of graph slices. The device uses an artificial intelligence model to make predictions as to whether each of the plurality of graph slices are indicative of the potential attack. The device makes a stability assessment as to whether the predictions are stable in part by assessing a gradient between predictions for neighboring graph slices in the plurality of graph slices. The device provides, based on the predictions and the stability assessment, an indication that the potential attack is an actual attack on the cloud computing environment.

Operationally, FIGS. 11A-11B illustrates an example of a visualization of a knowledge graph 1100 and contextual information 1110 usable in real time inference of attack presence with AI/ML, such as in conjunction with the teachings above. More specifically, FIG. 11A illustrates a visualization of the data presented in FIG. 11B.

As shown, knowledge graph 1100 may be representation of aggregated security findings with the data taking the form of complex objects (e.g., knowledge graph 1100). The visualized clusters S1 to S5 in the graph may illustrate how the underlying aggregated security findings are segmented and/or clustered.

It may be expected that, in real time, a system is tasked to classify a smaller graph corresponding to only a part of a larger (noisy) attack. That is, the classification of a subgraph rather than the full knowledge graph that might be obtained when observing a full attack. This subgraph may correspond to all the facts that have been collected during some window, defined either in terms of a duration of time or number of facts.

More specifically, three ways of constructing a subgraph in real time may be considered:
Collecting all facts in a time interval [t, t+w], where w denotes the window size in units of time;
Collecting a fixed number of facts nw; and/or
Collecting all facts until some condition is met (e.g., nothing has been observed during some time, Falco rules, etc.).

Further, the above windows can be overlapping or non-overlapping. Indeed, one could consider all the subgraphs corresponding to the time intervals [0,5], [5,10], . . . , or [0,5], [1,6], [2,7], etc. In this case, in addition to a window size w, the system may consider a so-called sliding window t, so that the system is able to construct n=int(1/τ* (tₘₐₓ−w)−(tₘᵢₙ+τ))) subgraphs, where tₘᵢₙ, tₘₐₓ denotes start and stop of an overall investigation time interval.

Alternatively, or additionally, on the one hand one could construct a subgraph containing the first one hundred facts, then a subgraph containing facts numbered one hundred and one to two hundred, a further subgraph containing facts two hundred and one to three hundred, and so on. While on the other hand, one could construct a graph containing the first one hundred facts, the next one containing facts five to one hundred and five, etc. The latter method, with overlapping intervals, may be referred to as a sliding window approach.

As a practical example, in the case of a crypto jacking attack for instance, a subgraph collected during a certain window could contain:
initial access plus some background activity;
only a part of initial access;
a part of initial access mixed with a part of discovery;
only a part of discovery;
both initial access and discovery;
etc.

In addition to the above, a choice can be made to attach contextual information 1110 (e.g., a process inside the subgraph is linked to a user or pod) collected outside the window, to each subgraph. This choice may depend on what information is actually available in real-time.

For these procedures to be able to recognize subgraphs in real-time, training may be done on data that takes a similar form. Hence, to mimic what happens in real-time, a graph corresponding to a full attack (or a combination of TTPs) may be split into smaller subgraphs. This split may be carried out as described above, to obtain subgraphs corresponding to either non-overlapping windows or to a sliding window, where cuts are based either on the indices of facts or on timestamps. Further, contextual information collected outside a window can optionally be included.

Altogether, a split may be defined in terms of three parameters: the window size (e.g., in terms of number of facts or time units), the distance between two consecutive windows (idem), and/or whether to include contextual information.

In various implementations, the system may obtain labelled data as follows:
A large graph containing only background activity can be split, and the individual subgraphs can be labelled as pure background activity;
A large graph containing a pure signal can be split, with the individual subgraphs labelled:
   simply as pure signal; and/or
   or as a multi-class label corresponding to the amount of each tactic present in the subgraph (e.g., 80% initial access, 20% discovery); and/or
A large graph containing both a signal and background activity can be split, with the individual subgraphs labelled:
   simply as signal (discretizing);
   as a multi-class label corresponding to the signal-background ratio in the subgraph (e.g., 80% signal, 20% background activity); and/or
   or as a multi-class label corresponding to the proportion of each tactic and background activity in the subgraph (e.g., 40% initial access, 20% discovery, 40% background activity).

FIG. 12 illustrates an example of an embedding approach 1200 to support real time inference of attack presence with AI/ML, such as in conjunction with the teachings above. As shown, embedding approach 1200 may be a procedure for entity and graph level embedding utilizable in real time inference of attack presence with ML. Two graphs, G1 and G2, are shown being transformed by an embedding function f, resulting in entity level embeddings 1202. The system may then further process the embeddings using another function w to generate graph level embeddings 1204.

As outlined above, embeddings may be needed at the graph level. Indeed, entity-level embeddings may be tailored for tasks at the entity-level such as clustering files or finding anomalous processes. These embeddings may have drawbacks when it comes to downstream tasks at the graph-level. For example, these drawbacks may include:
Entity-level embeddings are not necessarily unique (for instance in the TransE model)→this may complicate any downstream task using these embeddings.
The total dimension of entity-level embeddings grows with the graph size→for any downstream task, it may be useful for the embedding to have a fixed dimension.
Graphs of different sizes have embeddings of different sizes→it may be useful to be able to compare graphs of different sizes.

Now, the system can then construct a graph-level embedding Ψ(G) of a graph G in two different ways, according to various embodiments:
By directly constructing it from the input graph G;
Or, by first calculating a node-level embedding f(G) and then aggregating those embeddings into a total embedding for the graph as Ψ(f(G)).

The latter is schematically represented as embedding approach 1200.

Embedding approaches have been presented that have not been tailored for any specific downstream task. These approaches are optimized for representational power, that is, the embeddings are close for similar graphs and are invariant to permutations of the entities and separate dissimilar graphs in the embedding space. These requirements may seem minimal: the minimum that is needed to represent the graphs in the embedded space without losing too much information. The regions in the embedded space corresponding to different classes might, however, have complex forms (e.g., not necessarily linearly separable, etc.), this may not be a-priori clear. In case the embedding is obtained by training a parametric function (e.g., a graph embedding network), this function may be composed with another parametric function that is used to carry out the task on the embedding space (e.g., a classifier on the embedding space) and then learn both simultaneously.

As outlined in further detail below, graph embedding networks may include neural networks that map graphs to a fixed-size vector in Euclidean space. Further the neural network architecture may be chosen in such a way that the network becomes expressive enough.

In addition, as outlined in further detail below, graph random neural features may be simple functions on the space of graphs to the reals that can be combined into a single vector. When enough of such functions are combined, the embedding may have a large representational power.

Further, with respect to Wasserstein embedding for graph learning, the entity-level embeddings can be compared for different graphs by using an approximation to the optimal transport problem.

FIG. 13 illustrates an example 1300 of using vector spaces to assess the similarities between graphs which may be leveraged herein for real time inference of attack presence with machine learning. In some implementations, a system for real time inference of attack presence with machine learning may leverage deep graph similarly learning. For instance, graph embedding models or any other suitable model may be used for this purpose. Generally, a graph embedding model may consist of an encoder, propagation layers and an aggregator. The encoder and propagation layers together may calculate an embedding of the nodes and edges, whereas the aggregator may combine those into a single graph level representation (a single point in Euclidean space).

In the propagation layer, an embedding of each node may be iteratively calculated by aggregating information from nodes at a larger distance. Now, given a pair of graphs, both can be embedded into Euclidean space, and a similarity (or distance) between them can be calculated in a straightforward way. The encoder, propagator, and aggregator may be neural networks with learnable parameters that can be trained using examples of pairs of similar (and dissimilar) graphs in such a way that the graph level representations (embeddings) are close for similar input graphs.

The latter class of models may extend the neural network architecture, to compute the similarity score jointly on a pair of graphs (rather than embedding both of them independently first). The neural networks for a pair may be coupled. Note that these matching models operate on pairs, and cannot directly be used to embed a single graph.

These graph embedding models may be suitable for use with the disclosed system, since the computed embeddings may take into account a notion of similarity between graphs. The graph matching networks, however, may not meet the requirements of the system since they cannot directly be used to embed a single graph.

In some implementations, an architecture may be chosen for the propagation layer defined above and the aggregator function, so that the network has a high representational power. This may provide a simplified architecture, that manages to distinguish between most graphs, except for some esoteric examples.

In various implementations, a family of graph neural networks can be used to induce a metric on the space of all finite graphs. For this, graph neural features may be introduced as parametric maps ψ(·, w) which map from the space of finite graphs to real numbers and associate a real number to the adjacency matrix of a graph, in such a way that the mapping is invariant under node permutations, etc. When the parameters w are drawn from a probability distribution P, the function d_{P} (·,·), defined on a pair of graphs G₁, G₂ by

$${d}_{P} ( {G}_{1} , {G}_{2} ) = \sqrt{{E}_{w ∼ P} [ {( ψ ( {G}_{1} , w ) - ψ ( {G}_{2} , w ) )}^{2} ]}$$

may be a metric on the space of graphs. This may imply that d_{P}(G₁,G₂) can tell us how different two graphs G₁,G₂ are. This may lead to the following graph-level embedding ψ(G) of a graph G using a finite sample w₁, . . . , w_{M} of size M from P,

$$ψ ( G ) = {\frac{1}{\sqrt{M}} [ ψ ( G , {w}_{1} ) , … , ψ ( G , {w}_{M} ) ]}^{T} .$$

It may be proved that, in probability, that:

$$\vert ψ ( {G}_{1} ) - ψ ( {G}_{2} ) \vert \to {d}_{P} ( {G}_{1} , {G}_{2} )$$

as M→∞. This may mean that when M is large enough, the embedding ψ(G) of dimension M has all the properties needed:
   it maps a graph and all its permutations to the same embedding;
   it maps similar graphs G₁, G₂ to embeddings that are close;
   it maps dissimilar graphs G₁, G₂ further away in the embedded space.

The neural features ψ(·, w) may be short compositions of simple functions, and calculating them may be fast (e.g., mainly matrix multiplications parsed through two sigmoid functions). Further no learning may be required to construct the embedding (e.g., except for choosing the distribution P). For a given distribution P, it may be only the embedding dimension M that determines the “quality” of the embedding. An increasing dimension may imply a larger computational time and more space needed to store the parameters w₁, . . . , w_{M}, although both may be linear in the embedding dimension M.

However, this embedding method, as it is, may not take into account the task that follows (e.g., classifying the graph embeddings into malicious and benign corresponding graphs). The above-mentioned properties may guarantee that the embedding space can be divided into regions corresponding to the classes, but the boundaries of those regions might still have a very complex form.

In various implementations, an approximation to the problem of optimal transport may be utilized in order to compare entity-level embeddings. Roughly speaking, a graph-level embedding may be obtained by approximating the different between its entity-level embedding and a reference distribution. Interestingly, this approximation has a dimension that may be independent of the number of entities in the corresponding graph. This approach may not seem very natural for the outlined downstream tasks.

FIG. 14 illustrates an example of a visual summary 1400 of the application of different analytical methodologies to data slices in real time inference of attack presence with ML. Visual summary 1400 may be based on the following:
q(slicing): to learn how to classify in real-time smaller parts of a possible attack, large data can be split into smaller slices (based on timestamps/order of facts) that are labelled as either malicious or normal activity. A mapping transforming those small (but complex) slices into simple points in Euclidean space can then be learned (i.e., learning an embedding). Rolling may be added to this.
q(neighbors): final expectations (predictions) on some slices can be combined to have a more accurate decision at a larger time window (time of slice). Further, the timescales can be varied and the neighbor degree level can be defined (e.g., k=1, 2, etc.).
q(gradient): in addition, the predictions of kth degree neighbors (k=2, 3, 4, etc.) can be used to obtain its gradient. The gradient can be used to distinguish which predictions are stable or just an outlier. Here, it may be assumed that if an attack is detected, it should be present in predictions at least for some period of time. Thus, a gradient ˜0 shows a stable prediction, while a spike in the gradient indicates an outlier, that can be removed.
q(scanning) In addition, inference can be performed on different scales during a fixed period of time (e.g., a certain way of scanning). For example, within ten seconds ten inferences each 1 second, five inferences each two seconds, two inferences each five seconds and one global inference on ten seconds may be performed that can be combined to evaluate the stability of the prediction.

Visual summary 1400 may include visual slices of data in time which may be used to perform detection of an attack or not an attack. All approaches below can be combined in one certain methodology to increase confidence in detection and reduce false positives (misclassification of attack as not attack or vice versa).

Inference on independent data slices may provide no information about what happens before and after. However, they may still be valuable to consider in that it is assumed that the previous or next data slice should contain a portion of “signal” information that leads to detection. Here, the system can provide an average prediction rate in addition to single prediction to reduce “noisy” (false) predictions via combined neighbor ones (degree 1, 2, 3 . . . ).

The gradient may be calculated in rolling neighbor predictions (e.g., degree 2 as in image) around some targeted prediction. The mechanism may include using this information to reject “noisy” (false) predictions. It can be done setting a threshold. Steep raise/drop may suggest a random/false prediction, for example, when prediction was 0.15 and next 1.0 and later 0.0, which gives +0.85 and −1.0, both cases are with high gradient (in various implementations, for simplicity, it's just change for neighbor predictions).

For ten slices, ten predictions may be expected. The prediction set and post-process predictions may be enriched by scan via spanning slices. For example, two big slices of five small combined, five big slices of two small combined so that getting 10+5+2+1=18 predictions in total in this particular example. This may work somewhat as boosting the weak predictions toward more confident one.

It should be noted that while certain steps as described above may be optional, these steps are merely examples for illustration, and certain other steps may be included or excluded as desired. Further, while in some instances the steps are described in relation to a particular ordering, this ordering is merely illustrative, and any suitable arrangement of the steps may be utilized without departing from the scope of the implementations herein.

### Data Augmentation in Attack Simulations for Enhanced Attack Detection

As noted above, conventional approaches to attack simulations and threat detections fail to produce and utilize fata that is fully realistic with respect to attack scenarios. Consequently, such systems fail to recognize novel or slightly altered attack patterns, leading to vulnerabilities. In contrast, the techniques herein leverage data augmentation in attack simulations to enhance attack detection. For example, by combining components of simulated and/or real attacks and background activity into a knowledge graph, a more realistic mimicry of data may be achieved.

Operationally, FIG. 15 illustrates an example of a knowledge graph 1500 of an attack which may be utilized to provide enhanced attack detection during attack simulations.

With respect to the modeling of background activity, an objective may be to detect whether a threat or attack (e.g., signal) is carried out during a certain window of time, based on the knowledge graph that is constructed from the data collected during that window. In practice, whether an attack takes place or not, this data most likely contains background activity that is simultaneously taking place. Hence, the machine learning models employed for detection should be trained on data that contains labelled examples of pure signal, a mixture of signal and background activity (e.g., with varying proportions), and pure background activity. Here, labelled means that for a data sample knowledge exists as to which of those three categories it belongs.

In some instances, the algorithm may be trained on such data that has been collected during real activity. That is, it may be presented with (1) many examples of attacks being carried out while different background activity takes place and/or (2) many examples of pure background activity. Those examples can be constructed from a long activity that has been split into windows.

However, this kind of data may not be available. It might very well be infeasible to emulate this, since many different scenarios (e.g., for the background activity) have to be thought out. Further, it may be rather time consuming. Later on, data collected from the client can be useful, but may in any case have to be labelled manually (e.g., that is, detecting which activity contains a signal has to be done by more classical means).

As such, in various implementations, this background activity may be modeled. In addition to the reasons outlined above, this may be done for the following reasons:
To substitute for a (temporary) lack of example data. Without labelled data, the algorithms simply cannot be trained;
To augment the data, by producing more realistic examples that the algorithms can be trained on; and/or
To be able to better understand the machine learning algorithms (e.g., the graph embedding networks and the classifiers).

As for data augmentation, this may be practiced in many domains of machine learning. Indeed, when learning to classify images of a cat, one usually rotates and shifts those images, rather than asking the photographer to do redo the image with the cat in a slightly different position.

With respect to understanding the machine learning/AI algorithms, even imperfectly modelled data might be informative as to the limits of its capabilities, good values for the parameters (e.g., the embedding dimension), the usefulness of certain features, etc.

A modelling assumption, such as that the background activity takes place independently of an attack, may be made. For example, if background activity takes place during an hour, an attack carried out in the interval [5,10] minutes would be done identically in the interval [20,25] minutes, although the background activity itself differs between those two intervals. Further, if an attacker attempts to mimic this activity in order to obfuscate his attack, it may be assumed that the corresponding obfuscation activity has the same statistics.

Note that this modelling assumption may imply that an attack can, in principle, be “mixed” with any kind of background activity that has ever been recorded. Consequently, during training, examples may be presented where the same attack is mixed with background noise recorded at varying time intervals.

The mixing itself may be a crucial part of the modelling. In various implementations, slices of background activity may be modeled as subgraphs that are either inserted randomly into the knowledge graph of the attack, or replace certain edges (e.g., facts) in that knowledge graph. As an example, consider knowledge graph 1500 where the highlighted parts correspond to the attack activity, whereas the white parts correspond to background activity.

When attaching a subgraph to the knowledge graph, a choice may need to be made about the connecting edge(s) (e.g., facts). The sampling of such an edge may be done following empirically observed statistics.

FIG. 16 illustrates an example of a relabeling approach 1600 for relabeling entity names in each subgraph, to avoid collision. The modelling itself described herein may utilize subgraphs to construct augmented training data. Again, given a collection of knowledge graphs corresponding to observations of background activity, smaller subgraphs can be obtained by applying the splitting method outlined above. Each subgraph may then correspond to a time slice of different background activity. When such subgraphs are obtained from one knowledge graph, they may initially have overlapping entity names (e.g., “process-8084” or “file-tmp-runc-process218” might be present in multiple slices). To augment the data, the entity names may be relabeled in each subgraph, to avoid collision. Further, the timestamp on all the facts may be reset to be consistent with the remainder of the knowledge graph.

FIG. 17 illustrates an example of an empirical frequency table 1700 associated with subgraph insertion into an already existing knowledge graph. When inserting a subgraph into an already existing knowledge graph, two choices may need to be made:
The location of insertion; and/or
The relation(s) on the fact(s) connecting the subgraph to the knowledge graph.

As for the latter, not all relations may be valid or equally likely to occur in reality. For instance, a fact of the form “process-findings-process” may be valid, but “file-parent_of-cluster” may not. Further, according to empirical frequency table 1700, certain combinations occur more frequently. The frequencies in the latter may have been obtained from a relatively small sample of background activity and may be expected to become more reliable once more background activity becomes available for analysis.

When deciding on the fact that is to connect the subgraph to the knowledge graph, a system may sample it according to a probability distribution obtained from an empirical frequency table (e.g., empirical frequency table 1700). More specifically, given a list of “building blocks” (i.e., small subgraphs obtained after e.g., splitting a large knowledge graph of background activity), the following recursive procedure to add this noise to a knowledge graph of an attack may be utilized:
1. Choose uniformly at random a building block from the list of building blocks;
2. For the chosen building block, identify the type of the head (say type(u)) of its first fact and the type of the tail of its last fact (e.g., type(v));
3. Given the type(u), sample according to the frequency table a fact to connect it to somewhere in the knowledge graph. That is, sample the type of a head (say type(head)) and a relation according to the counts of all valid facts of the form (*, *, type(u)).;
4. Given the type(v), sample again according to the frequency table a fact to connect it to somewhere in the knowledge graph. That is, sample a relation and the type of tail (say type(tail)) according to the counts of all valid facts of the form (type(v), *, *); and/or
5. Depending on the selections from 3 and 4. consider the following cases:
   a. Samples have been obtained in both 3 and 4, and a fact of the form (type(head), *, type(tail)) is valid→Replace such a fact in the knowledge graph by the facts from 3 and 4, and the subgraph;
   b. A sample has been obtained in 3. Find an entity in the knowledge graph with type equal to type(head)→Add the subgraph to this entity by using the relation found in 3;
   c. Otherwise, return to 1.

As an example, consider a building block starting with a process, and ending with a process. In step 3., a fact may be sampled from [(process, links, process), (process, parent_of, process), (process, findings, process)], with weights [37, 37, 36]. Say, for instance, that (process, links, process) is sampled, which happens with probability 37/(37 +37+36). In step 4, a fact may be sampled from [(process, findings, file), (process, findings, network_flow), (process, links, process), (process, parent_of, process), (process, links, hostname), (process, findings, process),]. Let's say (process, findings, file) is sampled, which happens with probability 104/(104+1+37+37+30+36). Then, in step 5, it may be verified whether (process, *, file) is a valid form of a fact. It is, and therefore a fact of this form may be picked uniformly at random in the knowledge graph and replaced by the subgraph. That is, an edge may be added with relation “links” from the selected process in the knowledge graph to the first process in the subgraph. An edge may be further added with relation “findings” from the last process in the subgraph to the selected file in the knowledge graph.

Special attention may need to be paid to the context of each subgraph that is attached to the graph. Indeed, as described above, each subgraph is to be relabeled (e.g., the entities are given unique names, to avoid collision). But, in some instances, it may be very likely that one does not want to relabel context related entities such as pod, cluster, user, etc. For example, when attaching the subgraph, a choice may be made to identify clusters, pod, and users in the subgraph with clusters, pod, and users that already exist in the knowledge graph.

In total, there may be a number of parameters that have to be set: the window size, the order in the window (i.e., selection based on the indices of facts or on timestamps), whether we relabel the entities (most likely always the case), and/or which context we identify with already existing context in the graph (most likely pod, cluster and user).

FIG. 18 illustrates an example of an original knowledge graph 1800 for augmentation, in various implementations (e.g., This original data may be utilized for data augmentation in attack simulations of enhanced attack detections. Augmentation of real data may be utilized for the learning process. The augmented data may mimic real data and diversify it/enrich it. The augmentation process may avoid time-consuming simulations and provide smaller-scale changes that are not simulated. The augmentation may bring some noisiness to improve the generalization capacity of detection systems.

FIG. 19 illustrates an example of a graph 1900 of augmented network data. For example, the system may perform graph augmentation on graph 1800 from FIG. 18 over time. To do so, the system may combine components of simulated and/or real attack (A) and background (B) activity into a knowledge graph that mimics data that is realistic. More specifically, the augmentation may be achieved as follows:
(1) identify parts of attack and/or background activity that can reoccur in another context and use them as building blocks;
(2) extract those building blocks as ai, aj, . . . , ak, where ai, aj, ak∈A denotes a set of sub-graphs (slicing, sampling) of graph A;
(3) add random perturbations by removing and/or adding some nodes/edges;
(4) combine those building blocks into realistic activity: merge (ai, aj, . . . , ak) to form a new graph Ã—e.g., by adding building blocks 1902a-1902b to the knowledge graph as shown in FIG. 19;
(5) graph Ã is built from A by altering a fraction (0-X %) of the latter, where X/100 is a degree of augmentation (e.g., assume at least 50% of the original graph is not touched, otherwise it is more synthetic than real data).

FIG. 20 illustrates an example procedure 2000 (e.g., a method) for real time inference of attack presence with machine learning, in accordance with one or more embodiments described herein. For example, a non-generic, specifically configured device (e.g., device 200), such as a router, firewall, controller for a network (e.g., an SDN controller or other device in communication therewith), server, or the like, may perform procedure 2000 by executing stored instructions (e.g., threat detection process 248). The procedure 2000 may start at step 2005, and continues to step 2010, where, as described in greater detail above, the device may divide a knowledge graph that represents a potential attack on a cloud computing environment in a plurality of graph slices. In various implementations, different slices in the plurality of graph slices are associated with different time frames. In one implementation, nodes in the knowledge graph represent application entities in the cloud computing environment and edges in the knowledge graph represent their timestamped interactions. In various implementations, the device may also identify a particular graph slice that represents an activity that could occur in a new context and use the particular graph slice to augment the knowledge graph with one or more additional nodes. In various implementations, the knowledge graph is based on a simulation of the potential attack. In one implementation, the cloud computing environment is a Kubernetes environment. In further implementations, the knowledge graph is based in part on telemetry data from at least one of: a Falco daemonset, eBPF, a Fluent Bit data exporter, an Open Cybersecurity Schema Framework (OCSF) data collection utility, or an OpenTelemetry (OTel) collector.

At step 2015, as detailed above, the device may use an artificial intelligence model to make predictions as to whether each of the plurality of graph slices are indicative of the potential attack. In some implementations, the device may each of the plurality of graph slices into points in a Euclidean embedding space. In such cases, the artificial intelligence model may make the predictions based in part on how close the points are to those associated with a known attack type in the Euclidean embedding space. In some implementations, the device may also train the artificial intelligence model on graph-level features and topological features.

At step 2020, the device may make a stability assessment as to whether the predictions are stable in part by assessing a gradient between predictions for neighboring graph slices in the plurality of graph slices, as described in greater detail above. In some cases, this may entail preventing, by the device, one of the predictions from being used for attack detection based on its gradient being above or below a threshold.

At step 2025, as detailed above, the device may provide, based on the predictions and the stability assessment, an indication that the potential attack is an actual attack on the cloud computing environment

Procedure 2000 then ends at step 2030.

It should be noted that while certain steps within procedure 2000 may be optional as described above, the steps shown in FIG. 20 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

It should be noted that while certain steps as described above may be optional, these steps are merely examples for illustration, and certain other steps may be included or excluded as desired. Further, while in some instances the steps are described in relation to a particular ordering, this ordering is merely illustrative, and any suitable arrangement of the steps may be utilized without departing from the scope of the implementations herein.

While there have been shown and described illustrative implementations that provide for real time inference of attack presence with machine learning and for data augmentation in attack simulations for enhanced attack detection, it is to be understood that various other adaptations and modifications may be made within the spirit and scope of the implementations herein. For example, while certain implementations are described herein with respect to using certain elements, modules, components, architectures, etc. for the purposes of LLM-based threat hypothesis generation, the elements, modules, components, architectures, etc. are not limited as such and may be used for other functions, in other arrangements, in other functional distributions, in other implementations, etc.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as tangible, non-transitory, computer-readable medium having computer-executable instructions stored thereon that, when executed by a processor on a computer, cause the computer to perform a method. For example, the components and/or elements may be implemented as software being stored on a tangible (non-transitory) computer-readable medium (e.g., disks/CDs/RAM/EEPROM/etc.)

having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method comprising:
dividing, by a device, a knowledge graph that represents a potential attack on a cloud computing environment in a plurality of graph slices;
using, by the device, an artificial intelligence model to make predictions as to whether each of the plurality of graph slices are indicative of the potential attack;
making, by the device, a stability assessment as to whether the predictions are stable in part by assessing a gradient between predictions for neighboring graph slices in the plurality of graph slices; and
providing, by the device and based on the predictions and the stability assessment, an indication that the potential attack is an actual attack on the cloud computing environment.

2. The method as in claim 1, wherein different slices in the plurality of graph slices are associated with different time frames.

3. The method as in claim 1, further comprising:
mapping, by the device, each of the plurality of graph slices into points in a Euclidean embedding space.

4. The method as in claim 3, wherein the artificial intelligence model makes the predictions based in part on how close the points are to those associated with a known attack type in the Euclidean embedding space.

5. The method as in claim 1, wherein nodes in the knowledge graph represent application entities in the cloud computing environment and edges in the knowledge graph represent their timestamped interactions.

6. The method as in claim 1, wherein making the stability assessment comprises:
preventing, by the device, one of the predictions from being used for attack detection based on its gradient being above or below a threshold.

7. The method as in claim 1, further comprising:
identifying a particular graph slice that represents an activity that could occur in a new context; and
using the particular graph slice to augment the knowledge graph with one or more additional nodes.

8. The method as in claim 1, wherein the knowledge graph is based on a simulation of the potential attack.

9. The method as in claim 1, wherein the cloud computing environment is a Kubernetes environment.

10. The method as in claim 1, wherein the knowledge graph is based in part on telemetry data from at least one of: a Falco daemonset, eBPF, a Fluent Bit data exporter, an Open Cybersecurity Schema Framework (OCSF) data collection utility, or an OpenTelemetry (OTel) collector.

11. An apparatus, comprising:
one or more network interfaces;
a processor coupled to the one or more network interfaces and configured to execute one or more processes; and
a memory configured to store a process that is executable by the processor, the process when executed configured to:
divide a knowledge graph that represents a potential attack on a cloud computing environment in a plurality of graph slices;
use an artificial intelligence model to make predictions as to whether each of the plurality of graph slices are indicative of the potential attack;
make a stability assessment as to whether the predictions are stable in part by assessing a gradient between predictions for neighboring graph slices in the plurality of graph slices; and
provide, based on the predictions and the stability assessment, an indication that the potential attack is an actual attack on the cloud computing environment.

12. The apparatus as in claim 11, wherein different slices in the plurality of graph slices are associated with different time frames.

13. The apparatus as in claim 11, wherein the process when executed is further configured to:
map each of the plurality of graph slices into points in a Euclidean embedding space.

14. The apparatus as in claim 13, wherein the artificial intelligence model makes the predictions based in part on how close the points are to those associated with a known attack type in the Euclidean embedding space.

15. The apparatus as in claim 11, wherein nodes in the knowledge graph represent application entities in the cloud computing environment and edges in the knowledge graph represent their timestamped interactions.

16. The apparatus as in claim 11, wherein the apparatus makes the stability assessment by preventing one of the predictions from being used for attack detection based on its gradient being above or below a threshold.

17. The apparatus as in claim 11, wherein the process when executed is further configured to:
identify a particular graph slice that represents an activity that could occur in a new context; and
use the particular graph slice to augment the knowledge graph with one or more additional nodes.

18. The apparatus as in claim 11, wherein the knowledge graph is based on a simulation of the potential attack.

19. The apparatus as in claim 11, wherein the process when executed is further configured to:
train the artificial intelligence model on graph-level features and topological features.

20. A tangible, non-transitory, computer-readable medium storing program instructions that cause a device to execute a process comprising:
dividing, by the device, a knowledge graph that represents a potential attack on a cloud computing environment in a plurality of graph slices;
using, by the device, an artificial intelligence model to make predictions as to whether each of the plurality of graph slices are indicative of the potential attack;
making, by the device, a stability assessment as to whether the predictions are stable in part by assessing a gradient between predictions for neighboring graph slices in the plurality of graph slices; and
providing, by the device and based on the predictions and the stability assessment, an indication that the potential attack is an actual attack on the cloud computing environment.
